(19) United States
(12) Patent Application Publication
(10) Pub. No.: US 2002/0146950 A1
(43) Pub. Date: Oct. 10, 2002

(54) Antimicrobial materials

(76) Inventor: Jim Reich, South Salem, NY (US)

Correspondence Address: Edgar H. Haug, Esq., c/o FROMMER LAWRENCE & HAUG LLP, 745 Fifth Avenue, New York, NY, 10151, US

(21) Appl. No.: 09/837,739

(22) Filed: Apr. 6, 2001

(51) Int. Cl. B32B 27/04; B32B 5/02; B32B 27/12; D02G 3/00

(52) U.S. Cl. 442/96; 428/375; 442/123; 442/199

(57) ABSTRACT

The present invention relates to materials which absorb human body odor, or odors associated with humans, prevent production of human body odors, or odors associated with humans, and prevent the detection of human body odors, and odors associated with humans, by animals, The materials comprise polyester fibers and antimicrobial acetate fibers. The materials can be made into, for example, twill, fleece, jerseys and hunting garments, apparel, protective garments and hunting accessories made therefrom.

### FIELD OF THE INVENTION

The present invention is directed to an odor-absorbing and/or odor-preventing materials. More particularly, the invention provides a fabric comprised of polyester and acetate fibers combined to one another, wherein the polyester fiber provides, for example, durability, napability and dyeability to the fabric, and wherein the acetate fibers are comprised of at least one anti-microbial agent which imparts, for example, odor-absorbing, odor-reducing and odor-preventing properties to the fabric.

Documents cited herein in the following text are incorporated by reference.

### BACKGROUND OF THE INVENTION

Animals possess a keen sense of smell which enables them to recognize body odors emanating from humans, as well as other odors associated with humans. This poses not only a problem to big game hunters, as the odors warn the animals of an approaching human, but also creates a hazard to humans, wherein carnivorous predators may correlate the presence of human body odors, and those odors associated with humans, as evidence that human prey is in the vicinity. Traditionally, various fabrics and apparel systems, as well as methods of forming compositions and yarns, have been developed which, for example, prevent, mask or absorb body odors. These include, for example, applying a topical antimicrobial or deodorizing agent onto an already formed fabric to inhibit the production of body odors; designing apparel with a plurality of layers, wherein an intermediate layer contains activated charcoal; and manufacturing fabrics composed of untreated and treated layers, wherein an antimicrobial agent migrates from the treated layer to the untreated layer, thereby preventing microbial growth and subsequent generation of body odors.

With respect to the antimicrobial material claimed and disclosed in the present invention, reference is made to the following:

U.S. Pat. No. 6,000,057 relates to hunting apparel constructed from antimicrobial fabrics and methods of making and using such hunting apparel. The hunting apparel is said to comprise an inner layer of an antimicrobial fabric and an outer layer of an odor absorbing material.

U.S. Pat. No. 3,959,556 relates to natural fibers to which anti-microbial properties are imparted, such as cotton fibers and fabrics, by intimately admixing the naturally occurring fibers with synthetic fibers prepared by extruding a spinnable solution of a synthetic thermoplastic resin and at least 0.1% by weight of an antimicrobial agent into a strand having a denier of 1.5-60 dpf. The synthetic fibers are said to be characterized by the antimicrobial agent therein migrating to the fiber surface to form a coating thereon and then transferring to the naturally occurring fibers by physical contact as the amount of antimicrobial agent on the surface of the naturally occurring fibers diminishes. It is purported that additional antimicrobial agent then migrates to the surface of the synthetic fiber until equilibrium is re-established.

U.S. Pat. No. 4,343,853 relates to a fabric construction having a backing fabric and a face fabric. At least one of the fabrics is made at least in part of yarns formed from synthetic fibers which have incorporated thereunto an antimicrobial agent. In some embodiments a tie yam joins the two faces in plated relation. Even with minimal contact of the yarns in the two fabrics, the antimicrobial agent migrates from within the treated fibers in the one fabric to the surface thereof and transfers to the yams in the other fabric. Thus, it is purported that there is imparted antimicrobial protection to both fabric faces while maintaining the advantages of naturally occurring, untreated fibers in one of the fabrics.

U.S. Pat. No. 6,009,559 relates to articles of clothing adapted to be worn by and to substantially surround at least a portion of a person. The articles of clothing absorb odors emanating from that portion of the person which is substantially surrounded by the clothing preventing odors from escaping to the atmosphere. The odor-preventing agent is selected from the group consisting of activated charcoal, chlorophyll, baking soda, activated alumina, soda lime, zeolite, calcium oxide and potassium permanganate.

U.S. Pat. No. 6,040,251 relates to barrier webs that have certain physical qualities such as water resistance, increased durability, improved barrier qualities and the like. The '251 Patent further relates to a barrier web comprising a web that has been treated with a curable shear thinned thixotropic polymer composition, the fabric being adapted to be substantially impermeable to liquids, permeable to gases and impermeable to microorganisms. The barrier webs of the invention are either impermeable to all microorganisms or are impermeable to microorganisms of certain sizes. The '251 Patent also relates to fabrics that are capable of either selectively binding with certain microorganisms, particles or molecules depending upon the binding partners incorporated into the polymer before application to the fabric.

U.S. Pat. No. 5,880,044 relates to elvan (a ceramic material) and a plastic mixed and formed into a fiber. The fiber is made into non-woven fabric products having antimicrobial properties.

U.S. Pat. No. 5,856,248 relates to cellulose fibers and products comprising treated fibers to absorb body secretions and to substantially decrease microbial growth, the fibers being chemically treated with a water soluble salt of a transition metal and an alkali and after this with a solution of a bisbiguanide compound, forming a bond between the fibers, the transition metal and the bisbiguanide. Preferred are water-soluble cupric salts as a suitable hydroxide. A preferred bisbiguanide is chlorhexidine. The products purportedly can be yarns, knitted, woven, non-woven fabrics, paper gauze and especially bandages, wound dressings, pads, diapers, sanitary napkins, tampons, bed sheets, pants, garments, towels, socks, shoe linings and underwear. Preferably between 0.1 to 3.0 weight per cent copper calculated on the cellulose is bonded to the cellulose.

U.S. Pat. No. 5,856,245 relates to a barrier web comprising a fabric that has been treated with a curable shear thinned thixotropic polymer composition, the fabric being adapted to be substantially impermeable to liquids, permeable to gases and impermeable to microorganisms. The barrier webs of the present invention are either impermeable to all microorganisms or are impermeable to microorganisms of certain sizes. The '245 Patent also relates to fabrics that are capable of either selectively binding certain microorganisms, particles or molecules depending upon what binding partners are incorporated into the polymer before application to the fabric.

U.S. Pat. No. 5,790,987 relates to articles of clothing adapted to be worn by and to substantially surround at least a portion of a person. The articles of clothing can absorb odors emanating from that portion of a person which is substantially surrounded by the clothing preventing odors from escaping to the atmosphere.

U.S. Pat. No. 5,678,247 relates to odor-absorbing clothing articles particularly useful for hunting big game animals wherein the clothing incorporates an intermediate odor-absorbing layer or sheet of material comprising non-woven synthetic fibers impregnated with activated carbon powdered particles. It is said that the relatively low cost odor-absorbing sheet possesses a flexible, readily pliant characteristic which permits its incorporation into an article of hunting clothing to preserve the required comfort to the wearer. The odor-absorbing sheet includes a binder which upon drying, adheres the carbon particles to the synthetic fibers without causing the sheet to become stiff and unpliant. The preferred activated carbon loading is about 100 to 200 weight percent of the weight of the non-woven sheet material.

U.S. Pat. No. 5,856,005 relates to a permanently flame-retardant and anti-microbial air-textured yarn formed of a plurality of substantially longitudinally extending, permanently flame-retardant filaments defining a core, and a plurality of substantially randomly extending, permanently anti-microbial filaments disposed at least about the core, the anti-microbial filaments at least partially defining a boucle-like sheath about the core. A knit or woven fabric formed with the yarn and having at lease 5% by weight of the anti-microbial filaments characterized by an ability to pass, both after one commercial laundering and after 100 commercial launderings, both National Fire Protection Agency vertical flame retardancy test NFPA 701-1989 and at least the 85% reduction level of gram positive and gram negative bacteria of anti-microbial test NYS 63.

U.S. Pat. No. 3,072,534 relates to the finishing of textile materials, including fibers and articles formed therefrom, and to methods of imparting a durable antibacterial finish to such textile materials and to the materials thus treated.

U.S. Pat. No. 3,116,207 relates to a method of protecting textiles against the action of noxious organisms such as fungi and bacteria which protection is retained after repeated washing and cleaning operations.

U.S. Pat. No. 4,174,418 relates to bacteriostatic, water-insoluble complexes of zirconyl acetate with inorganic peroxides. Peroxides operative in forming these complexes are hydrogen peroxide, alkali metal perborates and alkali metal peroxydiphosphates. Processes for in situ formation and deposition of the insoluble complexes on the surfaces of cellulosic textiles are described. The textile finishes so produced inhibit the growth and spreading of odor- and infection-producing gram-negative and gram-positive bacteria on the treated textiles. The antibacterial activity imparted to the textiles is durable to repeated laundering.

U.S. Pat. No. 5,047,448 relates to shaped articles incorporating mixed particulate metals comprising fine particles of a first metal or a compound thereof capable of releasing a metal ion having a first antimicrobial function, and a second metal having an ionization tendency different from that of the first metal or a compound thereof capable of releasing a metal ion having a second antimicrobial function, together with a polyester compound having specific properties, dispersed therein, and thus being capable of effectively releasing gradually over a long period a trace amount of the metal ions having an antimicrobial function from the particulate metals and maintaining an excellent antimicrobial function. The '448 fibers have good durability of the antimicrobial function and are mildew resistant, in repeated washings and in service.

U.S. Pat. No. 5,254,134 relates to a textile finishing agent containing a water-soluble polysiloxane with polyether and epoxypolyether lateral chains and preferably moreover an antimicrobial substance, a crosslinking agent and catalysts.

U.S. Pat. No. 5,453,268 relates to a water-dispersible, antimicrobial and deodorant-finished product for fabrics comprising fine particles of an antimicrobial Schiff base derivative of an aminoglycoside as the active ingredient and a polyoxy-ethylenepolyalkylsiloxane for improving the resistance to washing. The antimicrobial and deodorant-finished product of the '268 Patent have a higher safety, good antimicrobial and deodorant effects and longer duration of the effects than those of the conventional products.

U.S. Pat. No. 5,383,236 relates to articles of clothing adapted to be worn by and to substantially surround at least a portion of a person. The articles of clothing absorb odors emanating from that portion of the person which is substantially surrounded by the clothing preventing odors from escaping to the atmosphere.

U.S. Pat. No. 5,565,265 relates to a liquid and stain resistant, antimicrobial fabric that can withstand the high temperatures required for transfer printing. A coating composition comprising a copolymer composition, an antimicrobial agent and a fluorochemical composition is applied to fabric such as polyester, to produce the coated fabric.

U.S. Pat. No. 5,539,930 relates to articles of clothing adapted to be worn by and to substantially surround at least a portion of a person. The articles of clothing can absorb odors emanating from that portion of the person which is substantially surrounded by the clothing preventing odors from escaping to the atmosphere.

U.S. Pat. No. 2,523,114 relates to improvements in parasiticidal preparations and improved fungicides, insecticides and germicides. The '114 Patent further relates to methods of protecting organic material subject to attack by low orders of organisms.

U.S. Pat. No. 3,862,326 relates to germicidal finishes for substrates subject to the accumulation or growth of microorganisms, methods for applying such finishes and to the substrates so finished. The invention further relates to germicidal or bactericidal or bacteriastatic compositions such as detergent compositions and to processes for employing the same. The germicidal agents are certain organo-bismuth compounds.

U.S. Pat. No. 3,547,688 relates to microbiocidal compositions prepared by complexing water-soluble biocidal metal salts with aziridinyl compounds to form solutions containing aziridinyl metal adducts. Substrates subject to biological attack, e.g., textiles, paper, wood, leather, certain plastics, etc., are wet with such compositions, dried and then heated to set the metal complex on the substrate and provide the substrate with microbiocidal effects, e.g., bactericidal, fungicidal, rot-proofing or self-sanitizing properties.

U.S. Pat. No. 4,206,514 relates to a sanitary footgear article in the form of a sock or stocking having adhering to the inner sole portion a multiplicity of resinous spots having embedded therein fine particles of copper, silver or copper-silver alloy.

U.S. Pat. No. 5,003,638 relates to a sterilized glove comprising a glove body and an organic polymer film layer containing an antibacterial zeolite and formed on the entirety of at least one surface of the glove body in an upheaval shape.

U.S. Pat. No. 5,180,585 relates to an antimicrobial composition comprising an inorganic particle with a first coating providing antimicrobial properties and a second coating providing a protective function, method for preparing the same and uses; further processes for producing polymeric articles and a method for controlling microorganisms.

U.S. Pat. No. 5,181,276 relates to infection resistant materials and or products made from a molten blend of at least one polymer and a compound having antioxidant, plasticizer and antiviral activity. Additionally, the '276 compound has a hydrophilic lipophilic balance of between 12 and 20. The preferred polymer, polyvinyl chloride, is blended with the antioxidant, plasticizer, antiviral compound NONOXYNOL-9 (alpha-nonylphenyl-w-hydroxypoly (oxy-1, 2-ethanediyl) to form the infection resistant material.

U.S. Pat. No. 5,232,769 relates to a microcapsule having a particle diameter of 2 to about 300 micrometers and comprising a substance acting to improve physiological conditions of human skin, for example, substances exhibiting such effects as skin whitening, aging preventive, humidity preservable, itch suppressive, pain-killing, or antiphlogistic ones, and/or aromatic agents contained within the filmy coating of synthetic high molecular substance. The microcapsule is not broken when making, processing, or laundering the textile structure, but is gradually broken when the textile structure is put on the human body, used for another purpose, or subjected to intentional application of friction or pressure thereto, and sustainedly releases acting substances contained therein. Treatment liquids comprising these microcapsules and binder, preferably containing a spraying agent, adapt the microcapsules to tightly adhere to textile structures such as stockings underwear, and bedclothes, thereby providing a textile structure to exhibit the aforesaid effects.

U.S. Pat. No. 5,388,349 relates to an insole for articles of footwear comprises an apertured top layer formed from a non-absorbent, thermally non-conductive thermoplastic material which is affixed to a stabilizing layer formed of a non-woven material. The stabilizing layer, in turn, is affixed to a barrier layer and/or a cushioning layer to form insoles for articles of footwear intended for different activities.

U.S. Pat. No. 5,566,395 relates to a disposable liner fitted against the inside surface of a sweatband of a cap or hat. The liner functions to absorb moisture and oils, and to eliminate odor. The liner wicks moisture away from a user and may hold moisture away from the hat. The liner may wick moisture to an evaporation region to be evaporated. The evaporation region may be separated from the hat by a cover layer to prevent wicking into the crown of the hat. The liner may be configured to adjust the size, and thus the fit of the hat on the head of the user. To secure a hat on the head of a user, the liner may include a compressible, foamed, polymeric core. The core may be treated with an antibacterial agent and a deodorizing agent for eliminating odors. To one side of the core is attached an adhesive layer for securing to the sweatband of the hat. The adhesive is selected for firmness yet easy removal and disposal of the liner. The adhesive may be heat-sensitive. Multiple layers of foamed polymeric substrates coated on two sides with adhesive may be adhered to one another for sizing a hat. The other side of the core is bonded to a fabric layer positionable against the forehead of a user. The fabric layer may be formed to have an absorbent layer, and may include a non-absorbent outer layer that transfers moisture but remains dry to the touch.

U.S. Pat. No. 5,595,750 relates to An antimicrobial composition comprising an inorganic particle with a first coating providing antimicrobial properties and a second coating providing a protective function is disclosed with a method for preparing the same and uses; further processes for producing polymeric articles and a method for controlling microorganisms are also disclosed.

U.S. Pat. No. 5,656,037 relates to the preparation of water-insoluble, bactericidal, peroxide-containing products, by reaction of magnesium acetate with hydrogen peroxide, and products obtained. Processes for application and deposition of these reaction products on natural, synthetic and blend fibrous substrates are also disclosed. The modified fibrous substrates thus produced inhibit the growth and spread of odor and disease-causing gram-positive and gram-negative bacteria and the antibacterial activity of the modified fibrous substrates is durable to repeated launderings.

U.S. Pat. No. 5,699,627 relates to components for the manufacture of a shoe including a shoemaker's last, a padded sole member, an insole assembly, an antiskid damping sole and a heel assembly. These components may be used together or combinations thereof may be used in the manufacture of shoes for women, men or children.

U.S. Pat. No. 5,727,336 relates to an insole for an article of footwear which includes an apertured top layer formed of a non-absorbent, thermally non-conductive thermoplastic material, a non-woven layer having a first portion formed of a mixture of moisture-wicking and moisture-absorbent fibers affixed to the top layer, and, optionally, a second portion including fibers which are non-adsorbent and non-absorbent, and, in various embodiments, a barrier layer and/or cushioning layer(s) forming a laminate in which the non-woven layer is sandwiched between the top layer and such other layers. The chemical formulation of the top layer of thermoplastic material can be varied to alter its coefficient of friction or degree of slip resistance of the insole depending upon the requirements of a particular application.

U.S. Pat. No. 5,738,937 relates to a breathable liner which includes an inner liner selected from highly advance fabrics which are carefully selected. A series of layers are provided outside the inner liner including foam material layers, breathable membranes, a supportive mesh or a moldable foam, and an outer shell fabric. An in-line skate using such a liner is also disclosed. Furthermore, the applicability of the liner to snowboard boots, alpine and cross country boots, as well as clothing is disclosed.

U.S. Pat. No. 5,778,702 relates to a double layer sock having an inner ply having a foot portion that is undyed and a dyed outer ply covering the inner ply and joined to the inner ply at an upper end of the inner and outer plies. The inner ply is formed of antimicrobial and/or hydrophobic yams. A method of making a double ply sock includes knitting a singular tubular garment having a first section formed of undyed yam and a second section of dyed yam. The undyed section is inserted into the dyed section forming a two-ply construction having an undyed inner ply.

U.S. Pat. No. 5,887,276 relates to a cooling cap made up with knitted net fabric of polyester yam comprises an outer open-meshed fabric for covering the front half part of the hemispheric part of the cap to receive the human head, an inner fine linen fabric for lining the outer open-meshed fabric, a water absorbent fiber layer for bearing water or absorbing sweat, and a plurality of eyelets or loopholes. The head is cooled owing to the vaporization of the water borne in the water absorbent fiber layer by absorbing the heat.

U.S. Pat. No. 5,951,799 relates to a method of manufacturing a shoe lining having anti-microbial properties. The method comprises providing a quantity of a thermoplastic resin including an inorganic zinc-based anti-microbial agent admixture having a predetermined microbial inhibition characteristic. This thermoplastic resin is blended with a polyethylene resin to form an anti-microbial feedstock. The anti-microbial feedstock is formed into relatively long, narrow, thin lengths of anti-microbial members. These members are woven into an anti-microbial fabric having predetermined microbial inhibition characteristics. This fabric is cut into a plurality of pieces in accordance with a predetermined pattern and the pieces are joined together thereby constructing the anti-microbial shoe lining.

DE 3917336 A1 relates to a protective material for atomic, biological and chemical protection consisting of a water- and wind-proof layer of crosslinked vinyl copolymer applied to the outside of the clothing.

EP 0 526 264 A1 relates to materials and production of clothing for protection against nuclear, biological and chemical agents consisting of an outer layer of cotton/polyester material which has been subjected to a water- and oil-repellant treatment and a layer of polyurethane foam impregnated with active carbon which is bonded to a layer of material such as a non-woven forming the inner layer of the material.

GB 1,222,502 relates to coated non-woven fabrics and to methods of forming them. The fabrics may be used, for example, as fitter media for the purification of gases or liquids, but are said to be useful for the construction of garments used for the protection of the body against contamination by contact with noxious gases, vapors and liquids.

GB 451,072 relates to metallized wearing apparel or parts thereof, of textile material or leather, for hygienic or therapeutic purposes.

JP 63-66302 relates to socks for inhibition of athlete's foot comprising wool containing 10-50% by weight of acryl polymer fiber, with fuzz index of the knitted thread of 60 or higher and pore volume of 75% or higher.

None of these patents provides for a combination of at least two fibers into a material, wherein one of the fibers comprises at least one antimicrobial agent, thereby rendering the material, and, in turn, for example, the apparel made from the material, capable of, for example, absorbing, preventing, or inhibiting the detection of body odors emanating from a human.

Thus, it is believed that heretofore the present invention has not been taught or suggested.

### OBJECTS AND SUMMARY OF THE INVENTION

An object of the present invention is to provide a novel material having an antimicrobial component. It is a further object of the present invention to provide a material that absorbs or prevents human body odors. It is still a further object of the present invention to provide a material that reduces odors associated with humans. It is yet another object of the present invention to provide a hunting garment capable of preventing human body odors, as well as other odors associated with humans, from being detected by animals. It is still yet another object of the present invention to provide apparel capable of preventing the emanation of human body odors, as well as other odors associated with humans.

In accordance with the present invention, an antimicrobial material is provided comprising a first fiber and a second fiber, wherein the first and second fibers are combined to one another, and the second fiber comprises at least one agent which imparts odor-absorbing and/or odor-preventing and/or odor-reducing properties to the material.

Further, and in accordance with the present invention, an antimicrobial material is provided comprising a first fiber comprised of a polyester and a second fiber comprised of an acetate, wherein the first and second fibers are combined to one another, the second fiber is at least about 25% by weight of the total fabric, and the acetate is comprised of at least one antimicrobial agent.

Still further, and in accordance with the present invention, a hunting garment is provided comprising a first fiber comprised of a polyester, and a second fiber comprised of an acetate, wherein the first and second fibers are combined to one another, and the second fiber comprises at least one agent which imparts odor-absorbing and/or odor-preventing and/or odor-reducing properties to the material.

Yet further, and in accordance with the present invention, a hunting garment is provided comprising a material comprised of a first fiber comprised of a polyester and a second fiber comprised of an acetate, wherein the first and second fibers are combined to one another, the second fiber is at least 25% by weight of the total material, and the acetate is comprised of at least one antimicrobial agent to impart

Yet further, and in accordance with the present invention, a hunting accessory is provided comprising a first fiber comprised of a polyester, and a second fiber comprised of an acetate, wherein the first and second fibers are combined to one another, and the second fiber comprises at least one agent which imparts odor-absorbing and/or odor-preventing and/or odor-reducing properties to the material.

Further, and in accordance with the present invention, a protective garment is provided comprising a first fiber, and a second fiber, wherein the first and second fibers are combined to one another, and the second fiber comprises at least one agent which imparts odor-absorbing and/or odor-preventing and/or odor-reducing properties to the material.

Still further, and in accordance with the present invention, an article of clothing is provided comprising a first fiber, and a second fiber, wherein the first and second fibers are combined to one another, and the second fiber comprises at least one agent which imparts odor-absorbing and/or odor-preventing and/or odor-reducing properties to the material.

Still further, and in accordance with the present invention, a method of manufacturing an antimicrobial material is provided, comprising weaving or knitting fibers comprised of a polyester fiber and an acetate fiber, wherein the acetate fiber comprises at least one antimicrobial agent in order to achieve an odor-absorbing, odor-reducing and/or odor-preventing property.

Additionally, and in accordance with the present invention, a method of manufacturing a hunting garment is provided, comprising weaving or knitting fibers comprised of a polyester fiber and an acetate fiber, wherein the acetate fiber comprises at least one antimicrobial agent in order to achieve an odor-absorbing, odor-reducing and/or odor-preventing property.

Still further, and in accordance with the present invention, a method of manufacturing a protective garment is provided, comprising weaving or knitting fibers comprised of a polyester fiber and an acetate fiber, wherein the acetate fiber comprises at least one antimicrobial agent in order to achieve an odor-absorbing, odor-reducing and/or odor-preventing property.

Yet additionally, and in accordance with the present invention, a method of manufacturing an article of clothing is provided, comprising weaving or knitting fibers comprised of a polyester fiber and an acetate fiber, wherein the acetate fiber comprises at least one antimicrobial agent in order to achieve an odor-absorbing, odor-reducing and/or odor-preventing property.

Yet further, and in accordance with the present invention, a method of manufacturing a hunting accessory is provided, comprising weaving or knitting fibers comprised of a polyester fiber and an acetate fiber, wherein the acetate fiber comprises at least one antimicrobial agent in order to achieve an odor-absorbing, odor-reducing and/or odor-preventing property.

In this disclosure, “comprises”, “comprising”, and the like can have the meaning ascribed to them in U.S. Patent Law and can mean “includes”, “including”, and the like. These and other objects and embodiments of the invention are provided in, or are obvious from, the following detailed description.

These and other objects and embodiments of the invention are provided in or are obvious from the following detailed description of the invention.

### BRIEF DESCRIPTION OF THE DRAWINGS

In the following detailed description, reference will be made to the accompanying drawings, wherein:

FIG. 1 is an enlarged schematic view of a first embodiment 100 in accordance with the present invention;

FIG. 2 is an enlarged schematic view of a second embodiment 200 in accordance with the present invention;

FIG. 3 is a photograph of a third embodiment 300 of the invention;

FIG. 4 is a graph comparing the results of a fabric odor test among the embodiments of the instant invention and those of a control;

FIG. 5 is a bar graph comparing the fabric odor test results of an embodiment of instant invention with a control jersey and a regular jersey;

FIG. 6 is a bar graph comparing the fabric odor test results of an embodiment of the instant invention with a control fleece and a regular fleece; and

FIG. 7 is a bar graph comparing the fabric odor test results of an embodiment of the instant invention with a control twill and a regular twill.

### DETAILED DESCRIPTION

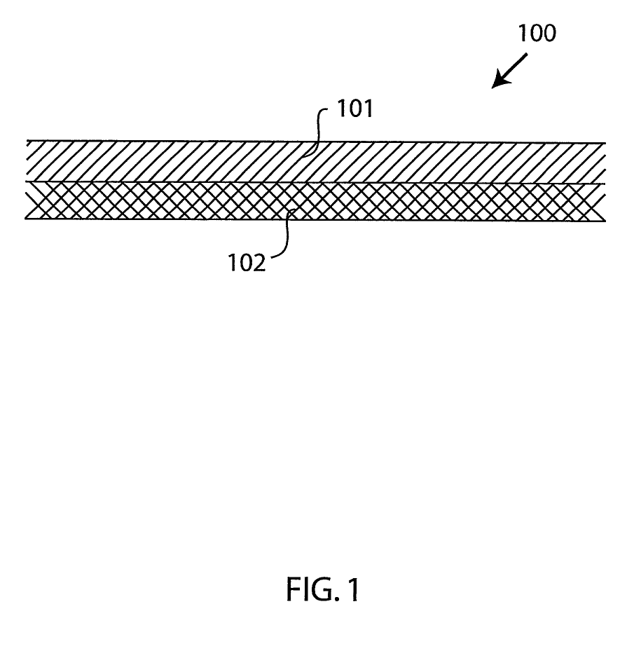

Reference is made to FIGS. 1, 2 and 3 depicting embodiments 100, 200, and 300.

As will be appreciated from the following, embodiment 100 in FIG. 1 is material in accordance with the present invention. Specifically, composition 101 is an antimicrobial acetate fiber manufactured by, for example, Hoechst Celanese in a range of deniers, such as 55/20, 75/20, 100/40 and 150/40. The fiber comprises acetate and at least one antimicrobial agent effective against, for example, odor-producing bacteria. Preferably, the concentration of the antimicrobial acetate fiber is about 25% by weight of the total fabric.

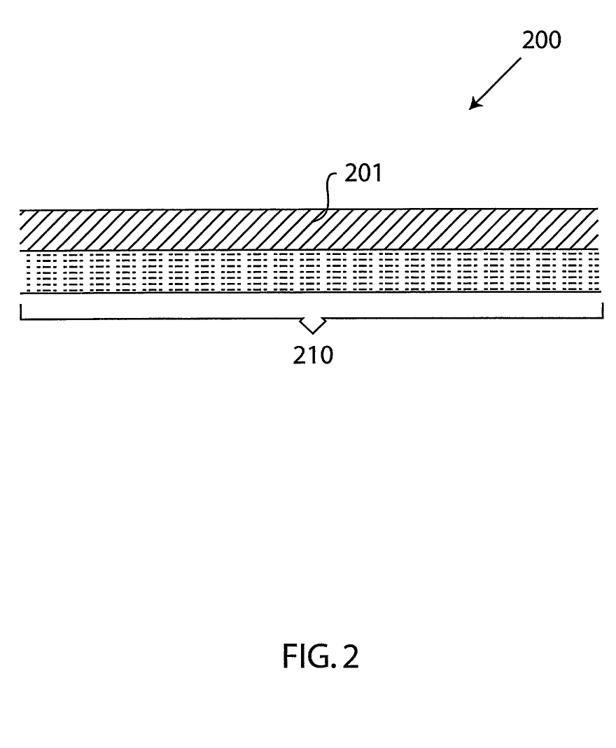

Composition 102 in embodiment 100 is comprised of a polyester fiber used in accordance with the present invention. Specifically, the polyester fiber is comprised of a 150 denier 68 filament or a 55 denier 20 filament. The polyester is semi-dull round disperse dyeable. “Semi-dull round” is preferred because it provides the fabric with a non-light-reflective property favored by hunters. “Disperse dyeable” is preferred because the polyester fiber will accept the full range of colors desirable when printing a camouflage pattern. Preferably, the concentration of the polyester fiber is about 75% by weight of the total fabric. As will be appreciated from the following, and as seen in FIG. 2, embodiment 200 is the combination of compositions 201 and 210 and is the preferred embodiment of the present invention. Specifically, combination of about 25% by weight of composition 201, which is comprised of the antimicrobial Triclosan, with about 75% by weight of composition 210 by an air-entanglement process results in a material with human body odor-absorbency, as well as absorbency of odors associated with humans, human body odor-prevention, as well as prevention of odors associated with humans, and the ability to prevent, at a minimum to reduce, human body odors, and odors associated with humans, from being detected by animals.

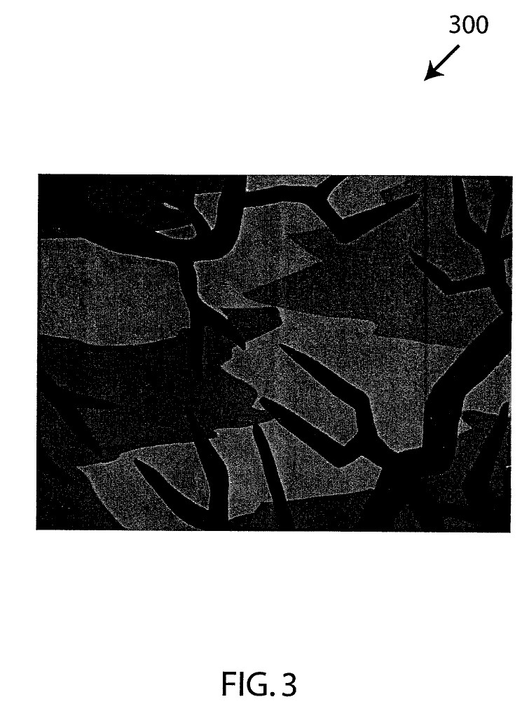

Embodiment 300 as seen in FIG. 3 is the third embodiment in accordance with the present invention. Specifically, embodiment 300 is a photograph of a fabric knitted or woven from the materials of embodiment 200 and then dyed and/or printed with a camouflage configuration. Embodiment 300 may be made into, for example, jerseys, twill, or fleece with or without a camouflage pattern. It is further envisioned that embodiment 300 may be made into other configurations, such as, for example, mosquito netting or any other configuration wherein human body odor-absorbency, human body odor-prevention, reduction of odors associated with humans, and the ability to reduce or prevent human body odors, and odors associated with humans, being detected by animals are desired. For example, it is contemplated that the invention is applicable for apparel, protective gear, and almost all hunting accessories including, but not limited to, gun cases, backpacks, bags, blinds, underwear, gloves, mitts and hats.

The present invention provides for an odor-absorbing and, among others, an odor-preventing material, and its methods for making and using the same. The material is comprised of at least a first fiber and a second fiber, wherein the second fiber comprises at least one antimicrobial agent. It will be understood that the first fiber and/or second fiber are either manmade or natural. A manmade first fiber includes, for example, polymeric fibers such as polyester. A manmade second fiber includes, for example, acetate fibers. It will also be understood that the fibers are combined in such a manner that the fiber comprised of the antimicrobial agent(s) will be dispersed throughout the fabric. It will be further understood that the antimicrobial agent will not, for example, leach-out or wash-out from the material. The material possesses the capability of, for example, absorbing human body odors, and odors associated with humans, preventing human body odors from being generated, and preventing human body odors, and odors associated with humans, from being detected by animals. An illustration of the material contemplated by the present invention is represented in FIG. 3 in the form of a hunting garment with a camouflage pattern.

The materials of the present invention, and the, for example, garments, apparel and articles of clothing made therefrom, achieve odor-adsorption, odor-prevention and prevention of odor detection by animals through the use of at least one polyester fiber and at least one acetate fiber, wherein the acetate fiber is comprised of at least one antimicrobial agent. Examples of polyester fibers include those manufactured by DuPont, Wellman, Nanya, Kosa and Universal. Further, a skilled artisan would understand that polyester fibers known as “commodity yarns” in the market may also be used. Polyester is advantageous because of its durability, the fact that it dyes well and also takes on color for both pigment and sublistatic printing desirable in the camouflage market. Polyester fibers include, for example, those with a range of about 70-300 denier; single strand or plied; and conventional or microdenier. Preferred polyester fibers include a 150 denier 68 filament and/or a 55 denier 20 filament. In these preferred polyester fibers, the polyester is semi-dull round disperse dyeable. “Semi-dull round” is preferred because it provides the fabric with a non-light-reflective property favored by hunters. “Disperse dyeable” is preferred because the polyester fiber will accept the full range of colors desirable when printing a camouflage pattern. Preferably, the concentration of the polyester fiber is about 75% by weight of the total fabric.

Examples of acetate fibers include those commonly used in the art. A preferred acetate fiber is an antimicrobial acetate manufactured by Hoechst Celanese known as Type 480 bright. The fiber is made in 55/20, 75/20, 100/40, and 150/40 deniers. The concentration of the antimicrobial agent is 2%. The preferred acetate fiber contains physical properties such as strength at 1.2-1.4 g/denier; elongation at 30%; a specific gravity of 1.32; and effectiveness even after 200 industrial washings. The antimicrobial properties attributable to the acetate fiber include effectiveness against Salmonella, molds/mildews, fungi, yeast infections, and certain respiratory and airborne infections. In a preferred embodiment, the concentration of the acetate fiber is about 25% by weight of the total fabric. It is understood that the factors in choosing an acetate include, for example, its antimicrobial properties, its availability in sizes that allow for desirable overall blend levels, and the overall odor-absorbing properties.

Examples of suitable antimicrobial agents are well known in the art and may be based on preference. One example of an antimicrobial agent is 5-chloro-2-(2,4-dichlorophenoxy) phenol, commonly known as Triclosan. Examples of other antimicrobials include those registered with the FDA for use in fibers. It will be understood, of course, that other antimicrobial agents capable of safely providing a material with the desired level of antimicrobial activity may be used. The antimicrobial agent is blended into an acetone mixture prior to formation of the acetate fiber by, for example, extrusion. Blending is the preferred method of incorporation of the agent into the acetate as it provides the acetate fiber, and, in turn the fabric, with antimicrobial permanence, wherein the antimicrobial agent will not, for example, leach- or wash-out after repeated use or repeated laundering. Such permanence cannot be achieved by, for example, topical administration of an antimicrobial agent. It is understood that “antimicrobial” is a generic term which also encompasses those agents possessing, for example, antibacterial, antifungal, and antibiocidal properties. Once the antimicrobial agent is blended into the acetate mixture, the acetate is made into a fiber by known methods in the art.

The acetate fiber and the polyester fiber are preferably combined by air entanglement. The air entanglement process comprises the polyester and acetate fibers being first wound onto a creel next to each other. As the fibers come off the creel, the fibers are entwined by using at least one air jet. Following combination of the acetate and polyester fibers by air entanglement, the combination is made into a fabric by known methods in the art, such as weaving on a beam or knitting. Examples of materials contemplated by the instant invention include, for example, hunting garments, hunting accessories, jerseys, fleece and twill, apparel, protective garments, and camouflaged variations thereof.

Further, it is contemplated that the materials of the invention are not limited to those for apparel. Indeed, it is to be understood that the present invention has a broad spectrum of utility, for example, the present invention can be used for mosquito netting, gun cases, backpacks, bags, blinds, underwear, gloves, mitts hats, and any other types of materials or products that require the property of odor-absorbency, odor-prevention and/or prevention of human body odors, or odors associated with humans, from being detected by animals.

It is further envisioned that other compounds or processes may be incorporated into the material, such as, for example, dyes, anti-static agents, water-repelling agents, wetting agents, laminating and embossing. It is envisioned that one or more additional compounds, such as additional acetates and antimicrobials, can be added to enhance the biocidal or physical properties of the material. Examples of enhanced physical properties include durability, napability and prevention of color-fade.

The following examples are set forth to illustrate examples of embodiments in accordance with the invention, it is by no way limiting nor do these examples impose a limitation on the present invention.

### EXAMPLES

### Example 1 Preparation of Material

A polyester fiber, in an amount of about 75% by weight, comprising a 150 denier 68 filament or 55 denier 20 filament, and characterized as semidull round disperse dyable, was combined with an antimicrobial acetate fiber, in an amount of about 25% by weight, purchased from Hoechst Celanese in any one of deniers 55/20, 75/20, 100/40 or 150/40. The combination is performed by an air-entanglement process, readily known in the art, and comprising winding the polyester and acetate fibers onto a creel next to one another, and then entwining the fibers using at least one air jet as the fibers come off the creel.

Once combined, the polyester and acetate were made into a fabric by known processes, such as, knitting or weaving. The fabric will contain antimicrobial properties and will absorb odors, absorb human body odor, prevent the generation of body odor and prevent human body odors, and other odors associated with humans, from being detected by animals. The antimicrobial will not wash- or leach-out, even after repeated use and repeated laundering. Depending on the method used and texture desired, the fabric may be made into, for example, hunting apparel, such as camouflaged twill, fleece, or jersey, or non-apparel such as, for example, mosquito netting, with or without a camouflaged pattern. Further, the fabric may be dyed, either before or after the polyester and acetate fibers are combined.

### Example 2 Results of Comparative Odor Testing Experiments

An analytical protocol was developed to measure and compare odor production as influenced by garments produced from various fabrics. Pouches containing a material which exhibits a high affinity for absorbing odor were secured to the outside underarm region of human subjects wearing various test garments. Following exposure, the pouches were subjected to independent laboratory analysis and total odor compounds were measured. Comparisons were performed on the fabrics of the present invention and regular fabrics using gas chromatography and mass spectrometry.

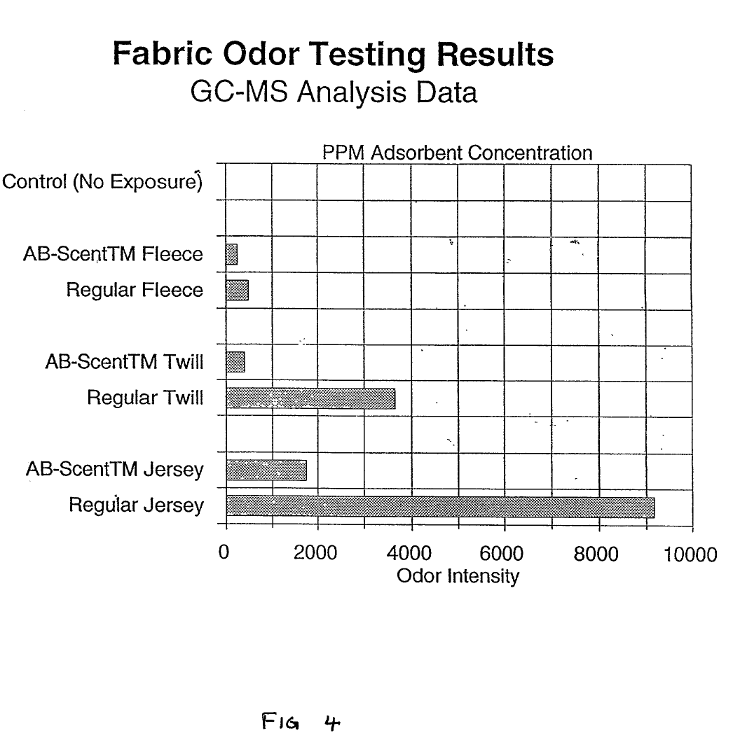

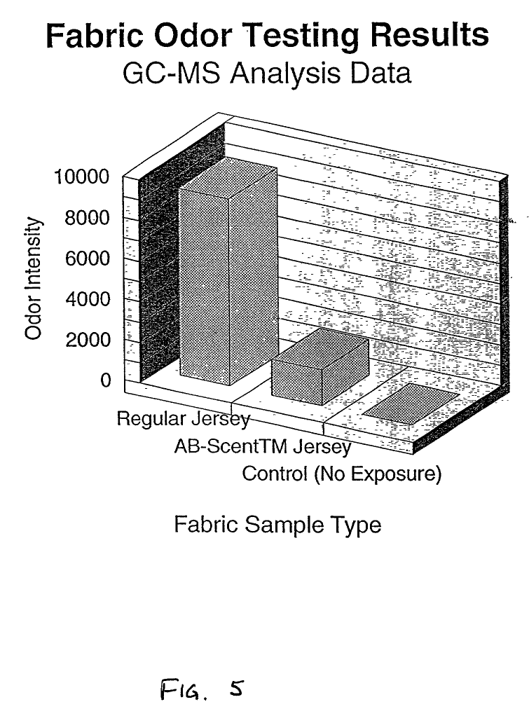

The test results are summarized in FIG. 4 as a chart comparing fabric sample type, and odor intensity as adsorbent concentration in parts-per-million. The individual comparisons are seen in FIGS. 5-7 which display the fabric type (fabric of the present invention, regular fabric and a control) versus the concentration of odor measured on the outside of the garment. The figures also list the percent reduction in odor which was achieved by the test fabrics relative to regular fabrics.

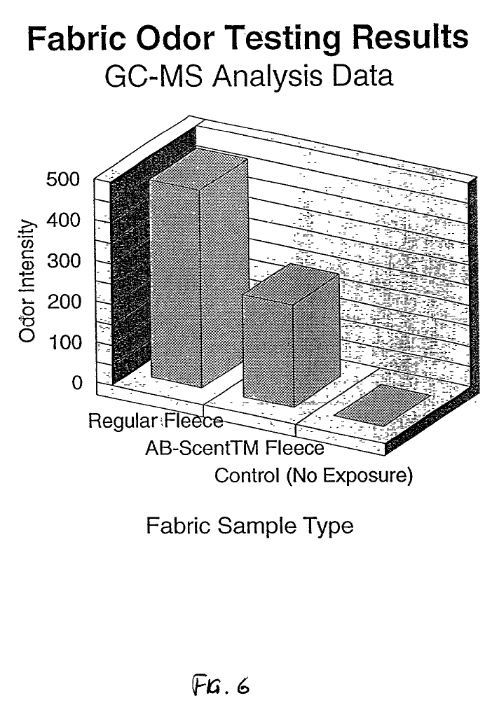

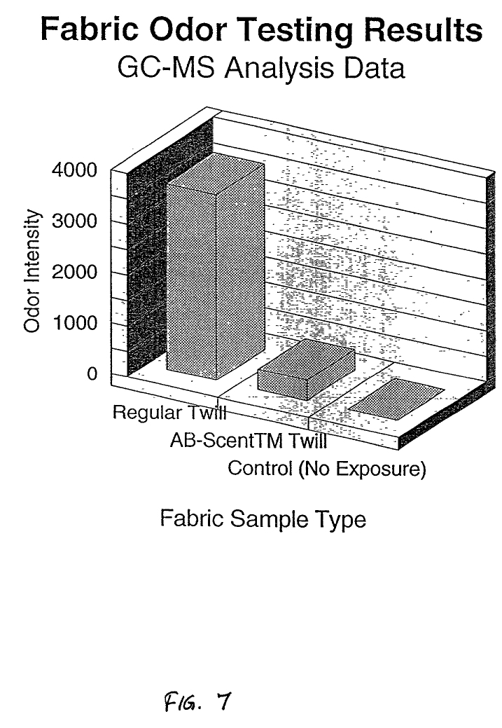

The tests confirm that a jersey made from the material of the present invention reduced odor by 81-83%, as compared to a regular fabric jersey (FIG. 5). In comparison tests of fleece garments made from the materials of the present invention and regular fleece fabrics, the fleece materials of the present invention showed significant reduction in odor, in the range of 33-48%, as compared to regular fleece fabric (FIG. 6). Finally, in a comparison test of twill material made from the material of the present invention and regular twill, the present invention reduced odors in the range of 89-91% (FIG. 7) as compared to regular twill.

It is also understood that the invention is not limited to the detailed description of the invention, which may be modified without departure from the accompany claims.

Having thus described in detailed preferred embodiments of the present invention, it is to be understood that the invention defined by the appended claims is not to be limited by particular details set forth in the above description, as many apparent variations thereof are possible without departing from the spirit or scope of the present invention.

What is claimed is:

1. An antimicrobial material comprising:
a first fiber; and
a second fiber,
wherein the first and second fibers are combined to one another, and the second fiber comprises at least one agent which imparts odor-absorbing and/or odor-preventing and/or odor-reducing properties to the material.

2. The material of claim 1, wherein the first fiber is manmade.

3. The material of claim 2, wherein the first fiber is a polyester.

4. The material of claim 1, wherein the second fiber is manmade.

5. The material of claim 4, wherein the second fiber is an acetate.

6. The material of claim 1, wherein the agent is antimicrobial, antifungal, or antibiocidal.

7. The material of claim 4, wherein the antimicrobial agent is Triclosan.

8. An antimicrobial material comprising:
a first fiber comprised of a polyester; and
a second fiber comprised of an acetate,
wherein the first and second fibers are combined to one another, the second fiber is at least about 25% by weight of the total fabric, and the acetate is comprised of at least one antimicrobial agent.

9. A hunting garment comprising:
a first fiber comprised of a polyester; and
a second fiber comprised of an acetate,
wherein the first and second fibers are combined to one another, and the second fiber comprises at least one agent which imparts odor-absorbing and/or odor-preventing and/or odor-reducing properties to the material.

10. A hunting accessory comprising:
a first fiber comprised of a polyester; and
a second fiber comprised of an acetate,
wherein the first and second fibers are combined to one another, and the second fiber comprises at least one agent which imparts odor-absorbing and/or odor-preventing and/or odor-reducing properties to the material.

11. A protective garment comprising:
a first fiber; and
a second fiber,
wherein the first and second fibers are combined to one another, and the second fiber comprises at least one agent which imparts odor-absorbing and/or odor-preventing and/or odor-reducing properties to the material.

12. A method of manufacturing an antimicrobial material, comprising weaving or knitting fibers comprised of a polyester fiber and an acetate fiber, wherein the acetate fiber comprises at least one antimicrobial agent in order to achieve an odor-absorbing, odor-reducing and/or odor-preventing property.

13. A method of manufacturing a hunting garment, comprising weaving or knitting fibers comprised of a polyester fiber and an acetate fiber, wherein the acetate fiber comprises at least one antimicrobial agent in order to achieve an odor-absorbing, odor-reducing and/or odor-preventing property.

14. A method of manufacturing a protective garment, comprising weaving or knitting fibers comprised of a polyester fiber and acetate fiber, wherein the acetate fiber comprises at least one antimicrobial agent in order to achieve an odor-absorbing, odor-reducing and/or odor-preventing property.
